(19) United States
(12) Patent Application Publication
(10) Pub. No.: US 2024/0367959 A1
(43) Pub. Date: Nov. 7, 2024

(54) CONVEYANCE ROBOT

(71) Applicant: TOYOTA JIDOSHA KABUSHIKI KAISHA, Aichi-ken (JP)

(72) Inventors: Yuta ITOZAWA, Nagoya-shi (JP); Kunihiro IWAMOTO, Nagakute-shi (JP); Hirotaka KOMURA, Tokyo-to (JP); Yutaro TAKAGI, Tokyo-to (JP); Uori KOIKE, Saitama-shi (JP)

(73) Assignee: TOYOTA JIDOSHA KABUSHIKI KAISHA, Aichi-ken (JP)

(21) Appl. No.: 18/644,103

(22) Filed: Apr. 24, 2024

(30) Foreign Application Priority Data
May 1, 2023 (JP) 2023-075460

(51) Int. Cl. B66F 9/075; B66F 9/065; B66F 9/18

(52) U.S. Cl. CPC B66F 9/0755; B66F 9/065; B66F 9/182

(57) ABSTRACT

A conveyance robot which contributes to the improvement of the accuracy of detection by a detection sensor is provided. A conveyance robot according to one aspect of the present disclosure is a conveyance robot configured to convey a rigid object to be conveyed, the conveyance robot including: a detection sensor configured to detect an environment in the vicinity of the conveyance robot; a mobile cart; a sensor pole part configured to support the detection sensor, the sensor pole part being vertically disposed on the mobile cart; and a coupling part configured to be coupled to a part to be coupled of the object to be conveyed, the coupling part being provided in the sensor pole part.

### CROSS REFERENCE TO RELATED APPLICATIONS

This application is based upon and claims the benefit of priority from Japanese patent application No. 2023-75460, filed on May 1, 2023, the disclosure of which is incorporated herein in its entirety by reference.

### BACKGROUND

The present disclosure relates to a conveyance robot, for example, to a conveyance robot conveying a rigid object to be conveyed.

For example, a general autonomous mobile robot moves based on information indicating an environment in the vicinity of the robot detected by a detection sensor mounted on the robot. At this time, it is preferable that the detection sensor be arranged in a position where detection of the environment in the vicinity of the robot is not inhibited when the robot moves. For example, in the robot disclosed in Japanese Unexamined Patent Application Publication No. H7-281753, the detection sensor is provided on a pan head of a mobile cart.

### SUMMARY

The applicant has found the following problem. The robot disclosed in Japanese Unexamined Patent Application Publication No. H7-281753 has a problem in which the accuracy of detection by the detection sensor is adversely affected by the shaking of the pan head when the robot is traveling.

The present disclosure has been made in order to solve the above-described problem and provides a conveyance robot which contributes to the improvement of the accuracy of detection by a detection sensor.

A conveyance robot according to one aspect of the present disclosure is a conveyance robot configured to convey a rigid object to be conveyed, the conveyance robot including:
a detection sensor configured to detect an environment in the vicinity of the conveyance robot;
a mobile cart;
a sensor pole part configured to support the detection sensor, the sensor pole part being vertically disposed on the mobile cart; and
a coupling part configured to be coupled to a part to be coupled of the object to be conveyed, the coupling part being provided in the sensor pole part.

In the conveyance robot described above, the coupling part may include a pin protruding downwardly from the sensor pole part or a hole extending in an up-and-down direction of the conveyance robot, the pin or the hole being provided in the sensor pole part, and the coupling part may be pin-coupled to a hole extending in an up-and-down direction of the object to be conveyed or a pin protruding upwardly from the object to be conveyed, the hole or the pin being provided in an upper end part of the object to be conveyed as the part to be coupled.

In the conveyance robot described above, the coupling part may include a friction plate protruding in a front-and-rear direction of the conveyance robot from the sensor pole part, and may be frictionally coupled to a friction surface provided in an upper surface of the object to be conveyed as the part to be coupled.

In the conveyance robot described above, the coupling part may include a magnet provided in the sensor pole part, and may be magnetically coupled to a magnet provided in the object to be conveyed as the part to be coupled.

In the conveyance robot described above, the sensor pole part may include a pole body and an installation part provided in an upper end part of the pole body, the detection sensor being provided in the installation part, and the pole body may be a wall extending in a left-and-right direction of the conveyance robot.

According to the present disclosure, it is possible to provide a conveyance robot which contributes to the improvement of the accuracy of detection by a detection sensor.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1A is a side view of a conveyance system according to a first embodiment;

FIG. 1B is a front view of the conveyance system according to the first embodiment;

FIG. 1C is a rear view of the conveyance system according to the first embodiment;

FIG. 2 is a diagram for explaining a shape of each of an engaging part of a conveyance robot and a part to be engaged of a conveyance cart according to the first embodiment;

FIG. 3 is a rear view showing a configuration of a conveyance system according to another embodiment;

FIG. 4 is a side view showing the configuration of the conveyance system according to the other embodiment; and

FIG. 5 is a side view showing the configuration of the conveyance system according to the other embodiment.

### DESCRIPTION OF EMBODIMENTS

Specific embodiments to which the present disclosure is applied will be described hereinafter in detail with reference to the drawings. However, the present disclosure is not limited to the following embodiments. Further, the following descriptions and the drawings are simplified as appropriate.

### First Embodiment

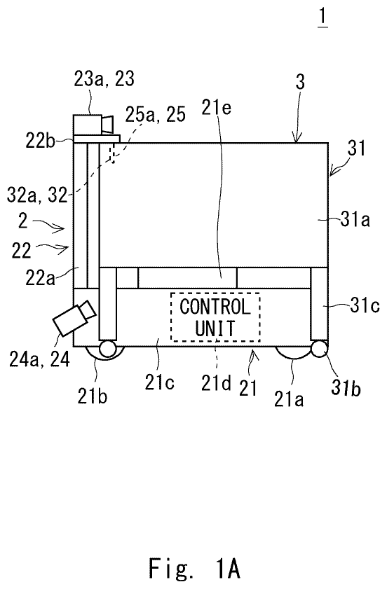

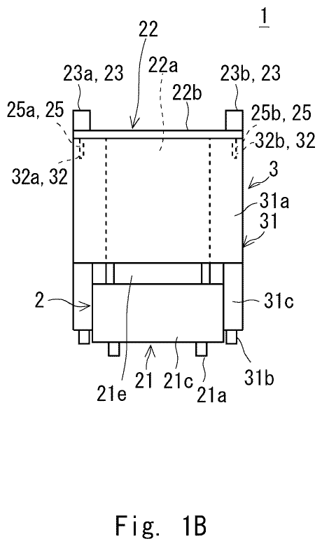

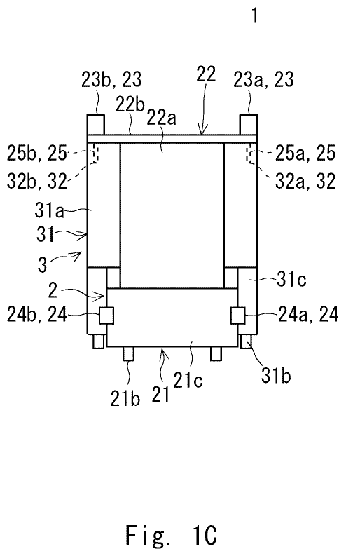

A conveyance system according to this embodiment is suitably used to convey a rigid object to be conveyed by a conveyance robot. FIG. 1A is a side view of the conveyance system according to this embodiment, FIG. 1B is a front view of the conveyance system according to this embodiment, and FIG. 1C is a rear view according to the conveyance system of this embodiment.

As shown in FIGS. 1A, 1B, and 1C, a conveyance system 1 includes a conveyance robot 2 and a conveyance cart 3. The conveyance robot 2 conveys the conveyance cart 3. The conveyance robot 2 includes a mobile cart 21, a sensor pole part 22, a first detection sensor 23, a second detection sensor 24, and a coupling part 25.

As shown in FIGS. 1A, 1B, and 1C, the mobile cart 21 has a structure in which left and right driven wheels 21a and left and right driving wheels 21b are provided in a base 21c, and a control unit 21d controls the left and right driving wheels 21b, thereby enabling forward, backward, and turning movements based on a rotation difference between the left and right driving wheels 21b. The base 21c may be, for example, substantially rectangular when viewed from the up-and-down direction, but the shape of the base 21c is not limited.

As shown in FIGS. 1A, 1B, and 1C, the mobile cart 21 has a structure in which an elevating machine 21e is provided in the base 21c, and the control unit 21d controls the elevating machine 21e, whereby the elevating machine 21e moves up and down relative to the base 21c. The elevating machine 21e may have any structure by which the conveyance cart 3 can be moved up and down, and the elevating machine 21e is disposed, for example, substantially at the center of the base 21c when viewed from the up-and-down direction. The above mobile cart 21 may have a structure, for example, in which it is autonomously controlled by the control unit 21d.

As shown in FIGS. 1A, 1B and 1C, the sensor pole part 22 protrudes upward from a rear end part of the base 21c. The sensor pole part 22 includes, for example, a pole body 22a and an installation part 22b. The pole body 22a may be, for example, a wall that is substantially rectangular when viewed from the up-and-down direction and extends in the left-and-right direction of the conveyance robot 2.

As shown in FIGS. 1A, 1B, and 1C, the installation part 22b is fixed to an upper end part of the pole body 22a. The installation part 22b may be, for example, a plate body that is substantially rectangular when viewed from the up-and-down direction and extends in the left-and-right direction of the conveyance robot 2. The upper surface of the installation part 22b may be disposed substantially horizontally in a state in which the left and right driven wheels 21a and the left and right driving wheels 21b of the conveyance robot 2 are in contact with the horizontal plane.

In this case, the width dimension of the installation part 22b in the left-and-right direction thereof may be, for example, greater than the width dimension of the base 21c in the left-and-right direction thereof as shown in FIGS. 1B and 1C. Further, a front end part of the installation part 22b may protrude forward from the pole body 22a as shown in FIG. 1A. The pole body 22a and the installation part 22b may be, for example, symmetrical about an axis passing through substantially the center of the left-and-right direction of the base 21c when viewed from the front-and-rear direction and extending in the up-and-down direction.

The first detection sensor 23 is fixed to the installation part 22b of the sensor pole part 22 as shown in FIGS. 1A, 1B and 1C in order to detect an environment in the vicinity of the conveyance robot 2. At this time, the first detection sensor 23 is mainly used, for example, to convey the conveyance cart 3 by the conveyance robot 2. Therefore, the first detection sensor 23 may be disposed at a position where it does not inhibit the detection of the environment in the vicinity of the conveyance robot 2 when the conveyance cart 3 is conveyed. In this embodiment, as shown in FIGS. 1A, 1B, and 1C, as the first detection sensor 23, a right first detection sensor 23a and a left first detection sensor 23b are provided. Further, the right first detection sensor 23a may be fixed to the right end part of the upper surface of the installation part 22b. Further, the left first detection sensor 23b may be fixed to the left end part of the upper surface of the installation part 22b.

The second detection sensor 24 is fixed to the base 21c as shown in FIGS. 1A, 1B and 1C in order to detect an environment in the vicinity of the conveyance robot 2. At this time, the second detection sensor 24 is mainly used, for example, when the conveyance robot 2 does not convey the conveyance cart 3. Therefore, the second detection sensor 24 may be disposed at a stable position of the conveyance robot 2 when the conveyance robot 2 travels in a state in which the conveyance cart 3 is not conveyed.

In this embodiment, as shown in FIGS. 1A, 1B, and 1C, as the second detection sensor 24, a right second detection sensor 24a and a left second detection sensor 24b are provided. Further, the right second detection sensor 24a may be fixed to the base 21c so that it protrudes from the right side of the base 21c. Further, the left second detection sensor 24b may be fixed to the base 21c so that it protrudes from the left side of the base 21c.

At this time, each of the right second detection sensor 24a and the left second detection sensor 24b may be disposed at a position where it does not interfere with the conveyance cart 3 when the conveyance cart 3 is conveyed by the conveyance robot 2. The first detection sensor 23 and the second detection sensor 24 described above may be sensors used for a general environmental recognition such as an RGBD camera or a Lider.

The coupling part 25 is coupled to a part to be coupled of the conveyance cart 3, which will be described in detail later. The coupling part 25 includes, for example, a right pin 25a and a left pin 25b as shown in FIGS. 1A, 1B and 1C. The right pin 25a and the left pin 25b are disposed at intervals in the left-and-right direction.

for example, as shown in FIGS. 1B and 1C, each of the right pin 25a and the left pin 25b is a columnar body that protrudes downward from a part of the installation part 22b of the sensor pole part 22 protruding forward from the pole body 22a.

That is, the right pin 25a and the left pin 25b extend in the up-and-down direction. For example, the right pin 25a and the left pin 25b may be symmetrical about an axis passing through substantially the center of the left-and-right direction of the base 21c when viewed from the front-and-rear direction and extending in the up-and-down direction.

The conveyance cart 3 houses a package in order to convey the package to the destination. The conveyance cart 3 includes, for example, a cart body 31 and a part 32 to be coupled as shown in FIGS. 1A, 1B and 1C. The cart body 31 includes a housing part 31a and casters 31b. The housing part 31a is, for example, a box body capable of housing a package, and is substantially rectangular when viewed from the up-and-down direction.

At this time, as shown in FIGS. 1B and 1C, the width dimension of the housing part 31a in the left-and-right direction may be substantially equal to the width dimension of the installation part 22b of the sensor pole part 22 of the conveyance robot 2 in the left-and-right direction. As shown in FIG. 1A, the length of the housing part 31a in the front-and-rear direction may be substantially equal to the length of a part of the base 21c of the mobile cart 21 of the conveyance robot 2 on the front side thereof with respect to the pole body 22a of the sensor pole part 22 in the front-and-rear direction. The height of the housing part 31a in the up-and-down direction may be lower than the height from the upper end part of the elevating machine 21e to the lower end part of the coupling part 25 in a state in which the elevating machine 21e is at a lowermost position in the mobile cart 21 of the conveyance robot 2.

The caster 31b is disposed, for example, at each of the four corners of the housing part 31a as viewed from the up-and-down direction, and each of the casters 31b is fixed to the housing part 31a via a support pillar 31c as shown in FIGS. 1A, 1B, and 1C. At this time, a distance between the left and right adjacent support pillars 31c is longer than the width dimension of the base 21c of the mobile cart 21 of the conveyance robot 2 in the left-and-right direction.

Further, the height from the lower end part of the caster 31b to the lower surface of the housing part 31a in the up-and-down direction is a height that allows the mobile cart 21 of the conveyance robot 2 to be inserted into the lower side of the housing part 31a of the cart body 31 of the conveyance cart 3 in a state in which the elevating machine 21e is at a lowermost position in the mobile cart 21 of the conveyance robot 2.

The part 32 to be coupled is coupled to the coupling part 25 of the conveyance robot 2. For example, as shown in FIGS. 1A, 1B, and 1C, the part 32 to be coupled includes a right hole 32a into which the right pin 25a of the conveyance robot 2 can be inserted, and a left hole 32b into which the left pin 25b of the conveyance robot 2 can be inserted.

For example, as shown in FIGS. 1A, 1B, and 1C, the right hole 32a and the left hole 32b are formed at the rear end part of the upper surface of the housing part 31a of the cart body 31 at intervals substantially equal to the intervals between the right pin 25a and the left pin 25b of the conveyance robot 2 in the left-and-right direction. The right hole 32a and the left hole 32b, for example, extend in the up-and-down direction and the shapes thereof respectively correspond to the shapes of the pins 25a and 25b to be inserted.

Next, a flow in which the coupling part 25 of the conveyance robot 2 is coupled to the part 32 to be coupled of the conveyance cart 3 according to this embodiment will be described. First, the mobile cart 21 of the conveyance robot 2 is inserted into the lower side of the housing part 31a of the cart body 31 of the conveyance cart 3 in a state in which the elevating machine 21e is at a lowermost position in the mobile cart 21 of the conveyance robot 2.

At this time, a worker may dispose the conveyance robot 2 or the conveyance cart 3 so that the relative position of the conveyance robot 2 to the conveyance cart 3 is a predetermined position, and the conveyance robot 2 may move based on a result of detection by the first detection sensor 23.

By doing so, the right hole 32a of the conveyance cart 3 is disposed directly under the right pin 25a of the conveyance robot 2, and the left hole 32b of the conveyance cart 3 is disposed directly under the left pin 25b of the conveyance robot 2.

Next, the elevating machine 21e of the mobile cart 21 of the conveyance robot 2 is moved up to move the conveyance cart 3 up, and the right pin 25a of the conveyance robot 2 is inserted into the right hole 32a of the conveyance cart 3 and the left pin 25b of the conveyance robot 2 is inserted into the left hole 32b of the conveyance cart 3. At this time, the conveyance cart 3 is supported by the conveyance robot 2 while it is floating.

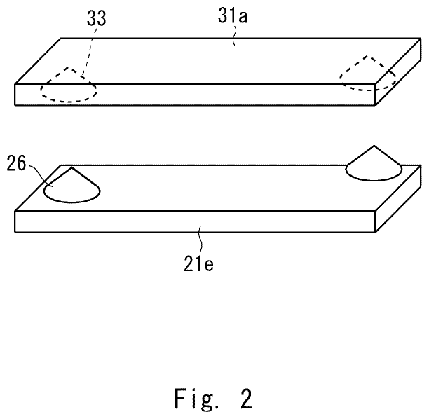

FIG. 2 is a diagram for explaining a shape of each of an engaging part of the conveyance robot and a part to be engaged of the conveyance cart according to this embodiment. As shown in FIG. 2, engaging parts 26, each of which has a projecting conical shape and has a diameter that is reduced toward the upper side, may be formed at intervals on the upper surface of the elevating machine 21e of the conveyance robot 2.

Further, parts 33 to be engaged, each of which has a recessed conical shape and has a diameter that is reduced toward the upper side, is formed on the lower surface of the housing part 31a of the cart body 31 of the conveyance cart 3, and the shape of the part 33 to be engaged may correspond to the shape of the engaging part 26 of the conveyance robot 2. The engaging part 26 of the conveyance robot 2 and the part 33 to be engaged of the conveyance cart 3 described above are engaged with each other when the relative position of the conveyance robot 2 to the conveyance cart 3 becomes a position near a predetermined position.

Thus, even when the relative position of the conveyance robot 2 to the conveyance cart 3 is slightly deviated from a predetermined position, the relative position of the conveyance robot 2 to the conveyance cart 3 can be guided to the predetermined position by the conical surfaces of the engaging part 26 and the conveyance cart 3 when the engaging part 26 of the conveyance robot 2 is engaged with the part 33 to be engaged of the conveyance cart 3.

Therefore, the coupling part 25 of the conveyance robot 2 can be easily coupled to the part 32 to be coupled of the conveyance cart 3. Note that, in this embodiment, although the engaging part 26 of the conveyance robot 2 has a projecting conical shape and the part 33 to be engaged of the conveyance cart 3 has a recessed conical shape, this configuration may be reversed.

Further, the elevating machine 21e of the mobile cart 21 of the conveyance robot 2 is further is moved up to move the conveyance cart 3 up, and the housing part 31a of the cart body 31 of the conveyance cart 3 is brought into contact with the installation part 22b of the sensor pole part 22 of the conveyance robot 2. In this way, work for coupling the coupling part 25 of the conveyance robot 2 to the part 32 to be coupled of the conveyance cart 3 is completed.

After that, the conveyance system 1 conveys the conveyance cart 3 to the destination based on a result of detection by the first detection sensor 23. Meanwhile, when the conveyance robot 2 moves in a state in which the conveyance cart 3 is not conveyed, the conveyance robot 2 moves based on a result of detection by the second detection sensor 24.

However, in a case in which, for example, the magnitude of the vibration of the conveyance robot 2 increases when the conveyance cart 3 is supported, the magnitude of the vibration of the conveyance robot 2 may be reduced in a state in which the conveyance cart 3 is not conveyed. In such a case, the conveyance robot 2 may move based on a result of detection by the first detection sensor 23 in a state in which the conveyance cart 3 is not conveyed. In this case, the second detection sensor 24 may be omitted.

In the above-described conveyance system 1, for example, when the conveyance robot 2 moves autonomously to convey the conveyance cart 3 based on a result of detection by the first detection sensor 23, the shaking of the sensor pole part 22 of the conveyance robot 2 can be suppressed since the coupling part 25 of the conveyance robot 2 is coupled to the part 32 to be coupled of the conveyance cart 3. Thus, the accuracy of the detection by the first detection sensor 23 can be improved.

Moreover, since the pole body 22a of the sensor pole part 22 of the conveyance robot 2 according to this embodiment is a wall extending in the left-and-right direction of the conveyance robot 2, the rigidity in the left-and-right direction is high, and the shaking of the sensor pole part 22 of the conveyance robot 2 can be further suppressed. Thus, the accuracy of the detection by the first detection sensor 23 can be improved.

Further, in this embodiment, the housing part 31a of the cart body 31 of the conveyance cart 3 is brought into contact with the installation part 22b of the sensor pole part 22 of the conveyance robot 2. In other words, by making the installation part 22b of the sensor pole part 22 of the conveyance robot 2 function as a friction plate, making the upper surface of the housing part 31a of the cart body 31 of the conveyance cart 3 function as a friction surface, and bringing them into contact with each other, the shaking of the sensor pole part 22 of the conveyance robot 2 can be further suppressed. Thus, the accuracy of the detection by the first detection sensor 23 can be improved.

However, when the coupling part 25 of the conveyance robot 2 is coupled to the part 32 to be coupled of the conveyance cart 3, the housing part 31a of the cart body 31 of the conveyance cart 3 need not be brought into contact with the installation part 22b of the sensor pole part 22 of the conveyance robot 2.

### OTHER EMBODIMENTS

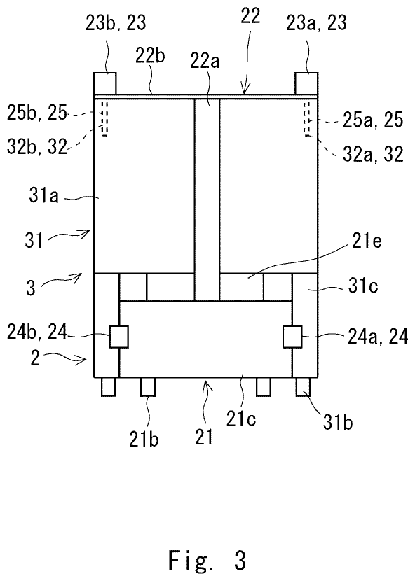

Although the pole body 22a of the sensor pole part 22 of the conveyance robot 2 according to the first embodiment is composed of a wall extending in the left-and-right direction of the conveyance robot 2, it may be composed of a bar body extending in the up-and-down direction as shown in FIG. 3.

The pins 25a and 25b of the conveyance robot 2 according to the first embodiment are columnar bodies extending in the up-and-down direction. However, for example, each pin may have a projecting conical shape and have a diameter that is reduced toward the lower side, and each of the holes 32a and 32b of the conveyance cart 3 may have a recessed conical shape corresponding to the shape of each of the pins 25a and 25b. Thus, it is possible to absorb the deviation of the relative position when the conveyance robot 2 is disposed relative to the conveyance cart 3. Further, the coupling part 25 of the conveyance robot 2 may include a hole, and the part 32 to be coupled of the conveyance cart 3 may include a pin.

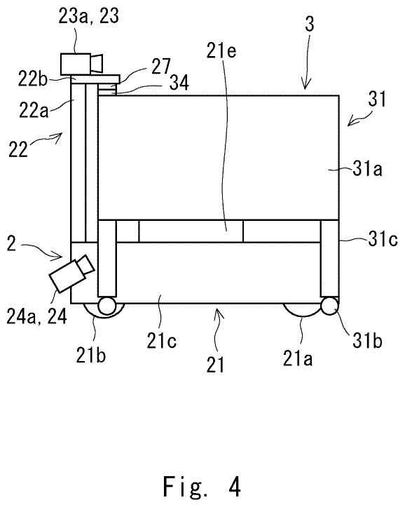

In the first embodiment, the coupling part 25 of the conveyance robot 2 may include the pins 25a and 25b, and the part 32 to be coupled of conveyance cart 3 may include the holes 32a and 32b. However, as shown in FIG. 4, a structure may be employed in which the coupling part 25 of the conveyance robot 2 includes a magnet 27, and the part 32 to be coupled of the conveyance cart 3 includes a magnet 34, and they are magnetically coupled to each other when the relative position of the conveyance robot 2 to the conveyance cart 3 is a predetermined position.

Further, a structure may be employed in which the coupling part 25 of the conveyance robot 2 includes a friction plate such as rubber, and the part 32 to be coupled of the conveyance cart 3 includes a friction plate such as rubber, and they may be brought into contact with each other and frictionally coupled to each other when the relative position of the conveyance robot 2 to the conveyance cart 3 is a predetermined position.

That is, means by which the coupling part 25 of the conveyance robot 2 is coupled to the part 32 to be coupled of the conveyance cart 3 are not limited to mechanical means, and a part of the conveyance cart 3 only needs to be in contact with the sensor pole part 22 of the conveyance robot 2.

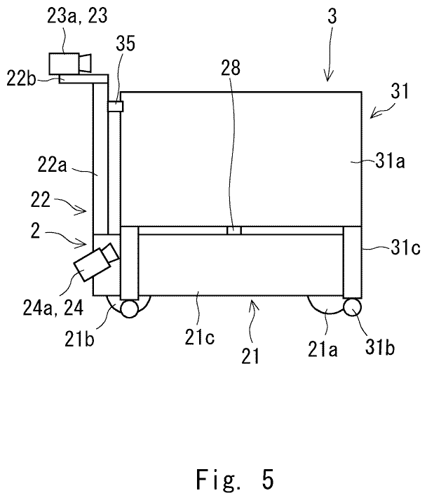

When the conveyance cart 3 according to the first embodiment is conveyed, the conveyance cart 3 is supported by the elevating machine 21e of the mobile cart 21 of the conveyance robot 2 while it is floating. However, as shown in FIG. 5, when the relative position of the conveyance robot 2 to the conveyance cart 3 is a predetermined position, a connection pin 28 provided in the mobile cart 21 of the conveyance robot 2 so as to be movable up and down may be coupled to the conveyance robot 2 by being inserted into an insertion hole (not shown) formed on the lower surface of the housing part 31a of the cart body 31 of the conveyance cart 3.

By doing so, the conveyance cart 3 follows the movement of the conveyance robot 2 while the casters 31b of the conveyance cart 3 are in contact with the ground. At this time, while the connection pin 28 of the mobile cart 21 of the conveyance robot 2 is being inserted into the insertion hole of the housing part 31a of the cart body 31 of the conveyance cart 3, a contact member 35 such as a rubber or a shock absorber provided in the housing part 31a of the cart body 31 of the conveyance cart 3 is brought into contact with the sensor pole part 22 of the conveyance robot 2, whereby the shaking of the sensor pole part 22 may be suppressed.

In this case, a part of the sensor pole part 22 of the conveyance robot 2 with which the contact member 35 of conveyance cart 3 comes into contact serves as the coupling part 25, and the contact member 35 of the conveyance cart 3 serves as the part 32 to be coupled. The conveyance robot 2 may be configured so that it can pull the conveyance cart 3. Further, an object to be conveyed is not limited to the conveyance cart 3, and may be an object to be conveyed that can be conveyed by the conveyance robot 2. For example, it may be an object to be conveyed that can be placed on the mobile cart 21 of the conveyance robot 2.

The present disclosure is not limited to the above-described embodiments and may be changed as appropriate without departing from the scope and spirit of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A conveyance robot configured to convey a rigid object to be conveyed, the conveyance robot comprising:
a detection sensor configured to detect an environment in the vicinity of the conveyance robot;
a mobile cart;
a sensor pole part configured to support the detection sensor, the sensor pole part being vertically disposed on the mobile cart; and
a coupling part configured to be coupled to a part to be coupled of the object to be conveyed, the coupling part being provided in the sensor pole part.

2. The conveyance robot according to claim 1, wherein the coupling part comprises a pin protruding downwardly from the sensor pole part or a hole extending in an up-and-down direction of the conveyance robot, the pin or the hole being provided in the sensor pole part, and the coupling part is pin-coupled to a hole extending in an up-and-down direction of the object to be conveyed or a pin protruding upwardly from the object to be conveyed, the hole or the pin being provided in an upper end part of the object to be conveyed as the part to be coupled.

3. The conveyance robot according to claim 1, wherein the coupling part comprises a friction plate protruding in a front-and-rear direction of the conveyance robot from the sensor pole part, and is frictionally coupled to a friction surface provided in an upper surface of the object to be conveyed as the part to be coupled.

4. The conveyance robot according to claim 1, wherein the coupling part comprises a magnet provided in the sensor pole part, and is magnetically coupled to a magnet provided in the object to be conveyed as the part to be coupled.

5. The conveyance robot according to claim 1, wherein the sensor pole part comprises a pole body and an installation part provided in an upper end part of the pole body, the detection sensor being provided in the installation part, and the pole body is a wall extending in a left-and-right direction of the conveyance robot.
